(19) United States
(12) Patent Application Publication
(10) Pub. No.: US 2007/0195905 A1
(43) Pub. Date: Aug. 23, 2007

(54) Forward error correction in wideband digital RF transport systems

(75) Inventor: Paul Schatz, Burnsville, MN (US)

Correspondence Address: FOGG & POWERS LLC, 10 SOUTH FIFTH STREET, SUITE 1000, MINNEAPOLIS, MN, 55402, US

(73) Assignee: ADC Telecommunications, Inc., Eden Prairie, MN (US)

(21) Appl. No.: 11/358,586

(22) Filed: Feb. 21, 2006

(51) Int. Cl. H04L 23/02

(52) U.S. Cl. 375/265

(57) ABSTRACT

Systems and methods for forward error correction in wideband digital RF transport systems is provided. In one embodiment, a method for transmitting digital data in a wideband digital RF transport system is provided. The method comprises receiving a first digital signal, wherein the digital signal includes a stream of digital RF packets, each digital RF packet comprising one or more data samples representing a digitized wideband RF spectrum; encoding error correction data into the stream of digital RF packets based on an error correction algorithm to produce a stream of modified packets; and transmitting a second digital signal comprised of the stream of modified packets via a communications medium.

### BACKGROUND

One of the biggest problems associated with designing and maintaining optical communications systems is compensating for the optical power loss and non-linearities, such as dispersion, that occur in the physical plant between an optical transmitter and optical receiver, and preserving a sufficient optical budget to maintain a reliable communications link. This problem often exacerbates itself over time due to degradation of the fiber medium and fiber connectors over time.

In the past, efforts to overcome optical power loss have mostly focused on improving the optical performance of the system. Such efforts included increasing the launch power of the optical signal, improving the quality of the optical transmitter's laser, improving jitter and timing characteristics at the optical receiver, improving the quality of the trans-impedance amplifiers and limiting amplifiers at the optical transmitter, and improving rise and fall times and the extinction ratio of the optical signal. The problem associated with each of these efforts is that each involves increases in equipment costs that are disproportionately expensive when compared to the amount of optical budget gained.

For the reasons stated above and for other reasons stated below which will become apparent to those skilled in the art upon reading and understanding the specification, there is a need in the art for economical systems and methods for improving optical budgets for communications networks.

### SUMMARY

The Embodiments of the present invention provide methods and systems for forward error correction in wideband digital RF transport systems and will be understood by reading and studying the following specification.

In one embodiment, a method for transmitting digital data in a wideband digital RF transport system is provided. The method comprises receiving a first digital signal, wherein the digital signal includes a stream of digital RF packets, each digital RF packet comprising one or more data samples representing a digitized wideband RF spectrum; encoding error correction data into the stream of digital RF packets based on an error correction algorithm to produce a stream of modified packets; and transmitting a second digital signal comprised of the stream of modified packets via a communications medium.

In another embodiment, a computer-readable medium having computer-executable program instructions for a method for communicating digital RF data in a communications network is provided. The method comprises inputting a stream of digital RF packets, wherein each digital RF packet comprises one or more data samples representing a digitized wideband RF spectrum; encoding each digital RF packet of the stream of digital RF packets with error correction data; and outputting a stream of error correction encoded data packets based on the digital RF packets.

In yet another embodiment, a communications network is provided. The network comprises means for encoding a stream of digital RF packets with error correction data based on a forward error correction algorithm, wherein each digital RF packet of the stream of digital RF packets comprises one or more data samples representing a digitized wideband RF spectrum, the means for encoding further adapted to output a stream of error correction encoded digital RF packets; and means for communicating a digital signal to a communication medium, the means for communicating responsive to the means for encoding, wherein the means for communication a digital signal is adapted to communicate the stream of error correction encoded packets to the communication medium.

In still another embodiment, a wideband digital RF transport system is provided. The system comprises a first communications network segment adapted to incorporate forward error correction data into one or more digitized data samples based on an error correction encoding algorithm, wherein the one or more digitized data samples represent a wideband RF spectrum signal, the first communications network segment further adapted to output a digital signal representing the forward error correction encoded data samples; a second communications network segment adapted to receive the digital signal and apply an error correction decoding algorithm to the error correction encoded data samples; and a communications medium coupled to the first communications network segment and the second communications network segment, the communications medium adapted to communicate the digital signal from the first communications network segment to the second communications network segment.

### DRAWINGS

Embodiments of the present invention can be more easily understood and further advantages and uses thereof more readily apparent, when considered in view of the described embodiments and the following figures in which:

FIG. 1 is a block diagram illustrating a digital network of one embodiment of the present invention;

FIG. 2 is a block diagram illustrating a communications network of one embodiment of the present invention;

FIG. 3 is a block diagram illustrating pre-emphasis and receive equalization of one embodiment of the present invention; and

FIG. 4 is a flow chart illustrating a method of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention provide improved methods and systems to overcome power loss in wideband digital RF transport systems over optical fiber through the application of forward error correction on the physical layer of a communications network. Forward error correction is a system of error control for data transmission that enables a data receiving device to detect and correct data corrupted by transmission errors. Forward error correction can be implemented either on existing computer hardware or with low cost new hardware at an existing plant site. Thus, embodiments of the present invention provide a significant increase in terms of dBm available to a receiver of a digital signal without the need for modifying installed communications media used in a communication network's physical layer. Embodiments of the present invention are not error correction algorithm specific and taking advantage of future improvements in error correction algorithms are contemplated.

In embodiments of the present invention, forward error correction is accomplished by adding redundancy to wideband digital RF data using a predetermined algorithm. This redundancy allows systems receiving the wideband digital RF data to both detect whether an error has occurred, and if so, to restore the correct information. The particular forward error correction algorithm chosen is readily determined by one skilled in the art upon reading this specification, from currently existing or yet to be developed algorithms. As embodiments of the present invention are not forward error correction technique specific, embodiment taking advantage of future improvements in forward error correction algorithms and coding techniques are contemplated as within the scope of embodiments of the present invention.

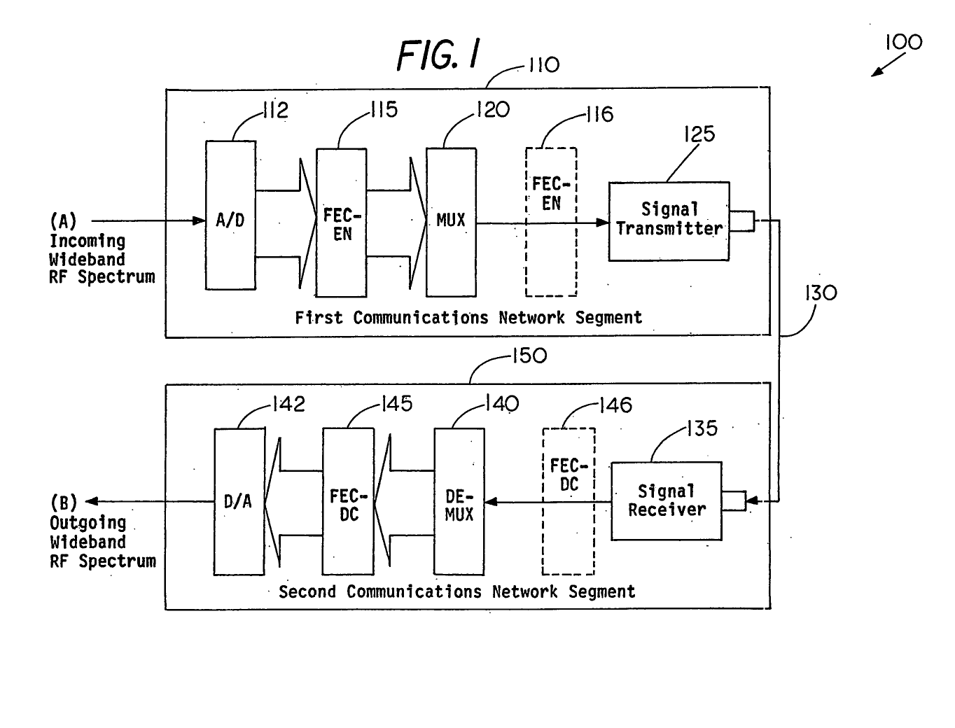

FIG. 1 is a block diagram illustrating a wideband digital RF transport system 100 of one embodiment of the present invention. One or more wideband RF spectrum signals enter system 100 at point A and are converted into a digital signal by first communications network segment 110. The digital signal is transported over a communication medium 130 to second communications network segment 150. In one embodiment, second communications network segment 110 reconverts the digital signal into a wideband RF spectrum signal that leaves system 100 at point B.

To provide practical transport in system 100, there must be a sufficient optical power margin within the system to overcome signal losses caused by communication medium 130. Physical components necessary to provide the necessary transport budget can be of significant cost and complexity depending on the digital method of transport. To reduce this cost and increase the loss budget, forward error correction (FEC) is encoded into the digital transport signal by first communications network segment 110 prior to transmitting the signals on communication medium 130. As would be appreciated by one skilled in the art, forward error correction techniques, which can often be implemented using existing hardware at many installations, allow the use of less expensive physical components for system 100 with an equivalent loss budget as that of non-forward error correction systems utilizing more expensive physical medium transport components.

In one embodiment, a wideband RF spectrum signal enters first communications network segment 10 and is converted into the digital signal by analog to digital converter 112. In one embodiment, the digital signal comprises a string of digital RF packets distributed across a plurality of bands of the wideband digital RF transport. In one embodiment, each digital RF packet includes a complex data sample of the wideband RF spectrum signal. In one embodiment, the digital RF packets comprise a 16-bit complex data sample of the wideband RF spectrum signal. First communications network segment 110 further comprises a forward error correction encoder (FEC-EN) 115, a wideband signal multiplexer 120 (MUX), and a signal transmitter 125.

In one embodiment forward error correction encoder 115 (FEC-EN) inputs the wideband digital signal from analog to digital converter 112 and evaluates the contents of the digital RF packets traveling though each band of the wideband digital signal. Forward error correction encoder 115 executes a predetermined forward error correction encoding algorithm that inputs the digital signal from analog to digital converter 112, calculates forward error correction data, and incorporates the forward error correction data into each of the digital RF packets to produce an FEC modified packet.

In one embodiment, forward error correction encoder 115 applies an error correction encoding algorithm based on one or both of block coding and convolutional coding. Examples of block coding include, but are not limited to Reed-Solomon coding, Golay coding, BCH coding and Hamming coding. Examples of convolutional coding include, but are not limited to the Viterbi algorithm. In one embodiment, forward error correction encoder 115 applies an encoding algorithm based on turbo coding, a scheme that combines two or more relatively simple convolutional codes and an interleaver to produce a block code. Examples of turbo coding include, but are not limited to 1xEV-DO (TIA IS-856). Other forms of forward error correction algorithms which may be utilized by embodiments of the present invention include, but are not limited to check bits, digital fountain code, differential space-time code, erasure codes, binary Golay codes, ternary Golay codes, Hagelbarger code, Hamming code, a low-density parity-check (LDPC) code, Reed-Muller code, and space-time trellis codes (STTCs). As would be appreciated by one skilled in the art upon reading this specification, the choice of which forward error correction algorithm can be readily determined by based on network specifics.

In one embodiment, multiplexer 120 inputs the FEC modified packets received from forward error correction encoder 115 and multiplexes the FEC modified packets into a serial stream of packets for serial transmission on communications medium 130. In an alternate embodiment, instead of locating forward error correction encoder 115 before multiplexer 120 in the signal path, multiplexer 120 multiplexes the digital RF packets from A/D 112 into a serial stream of packets and a forward error correction encoder (FEC-EN) (shown at 116) evaluates the contents of the digital RF packets traveling though serialized stream of packets to calculate forward error correction data as described above with respect to forward error correction encoder 115, and incorporates the forward error correction data into each of the digital RF packets to produce an FEC modified packet. Signal transmitter 125 transmits the stream of FEC modified packets to the second communications network segment 150 via communications medium 130.

In the embodiment shown in FIG. 1, communications medium 130 comprises one or more high speed digital data transport mediums. In one embodiment, communications medium 130 comprises one or more optical fibers. As would be understood by one in the art upon reading this specification, communications medium 130 is not limited to optical fiber media but in other embodiments of the present invention may also include other transport media such as copper wire, coaxial cable, twisted pair cable, or other electrical signal media, or a wireless communication link. In one embodiment, when communications medium 130 includes an optical fiber media, signal transmitter 228 is an optical transmitter such as, but not limited to a laser transmitter.

In one embodiment, the second communications network segment 150 comprises a signal receiver 135, a wideband signal demultiplexer 140 (DE-MUX), and a forward error correction de-coder (FEC-DC) 145, and a digital to analog converter 142.

Signal receiver 135 receives the digital signal comprising a string of FEC modified packets and communicates those packets to wideband signal demultiplexer 140. Wideband signal demultiplexer 140 in turn demultiplexes the packets from the serialized stream back into a digital wideband signal. Forward error correction decoder 145 reads the FEC modified packets from the wideband signal output of demultiplexer 140 and evaluates the forward error correction data incorporated into each FEC modified packet to determine whether the digital RF packet arrived error-free. When the packet is determined to be error-free, forward error correction decoder 145 strips the forward error correction data to restore the original digital RF packet and outputs the restored digital RF packet. In one embodiment, forward error correction decoder 145 forwards the restored digital RF packet to digital to analog converter 142. In one embodiment, when an error is detected within an FEC modified packet, forward error correction decoder 145 reconstructs the original digital RF packet based on information contained within the forward error correction data as described above, and outputs a corrected digital RF packet. In one embodiment, digital to analog converter 142 digital RF packets received from forward error correction decoder 145 into a wideband RF spectrum signal.

In an alternate embodiment, instead of locating forward error correction decoder 145 after demultiplexer 140 in the signal path, a forward error correction decoder (FEC-DC) (shown at 146) evaluates the contents of the serialized stream of packets digital RF packets from communications medium 130 before demultiplexer 140 in turn demultiplexes the packets from the serialized stream back into a digital wideband signal.

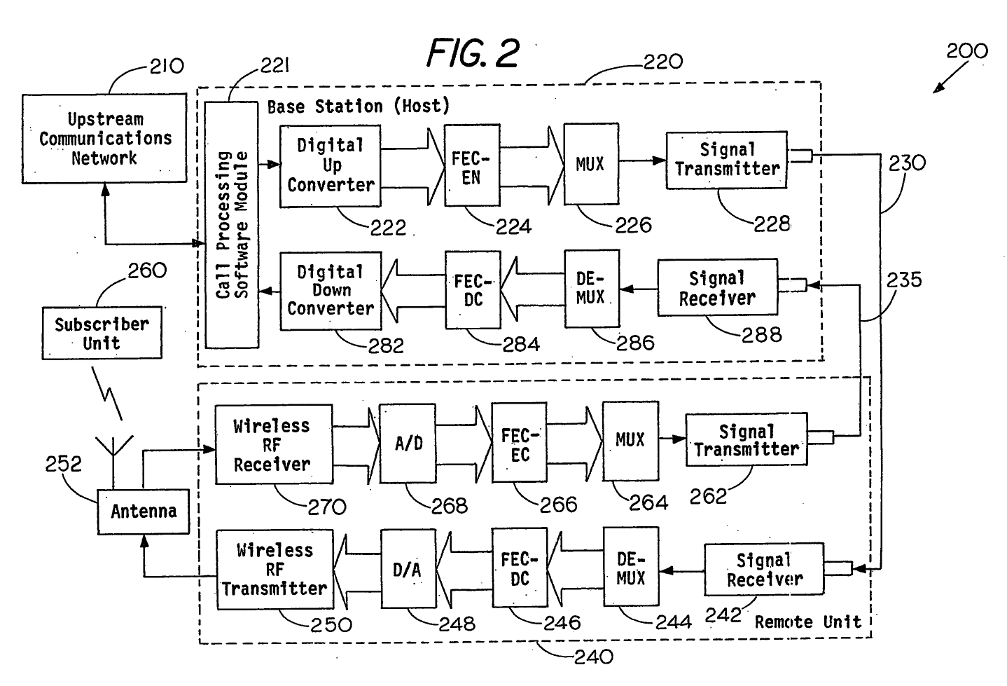

FIG. 2 illustrates another communications network 200 of one embodiment of the present invention. Communications network 200 concerns portions of a software defined radio system, such as a cellular telecommunications network, that typically comprise cellular antennas, a remote unit transmitting and receiving voice and/or data communications over the cellular antennas, and a base station (also commonly called a base transceiver station (BTS), or a server) that communicate voice and data signals between the remote unit and a larger communication network (e.g. the public switched telephone network, or the Internet). Communications network 200 includes one or more subscriber units 260 within a service area of a remote unit 240. Remote unit 240 is coupled to a base station 220 over one or more communications mediums such as communications mediums 230 and 235. Base station 220 is connected to one or more upstream communications networks 210 (for example, the public switched telephone network (PSTN), the Internet, a cable network, or the like). At least one antenna 252 coupled to remote unit 240 communicates signals between the one or more subscriber units 260 and remote unit 240.

In one embodiment, communications network 200 is a bidirectional network and as shown includes equipment for forward links (i.e., transmissions on forward logical channels from upstream communications networks 210 to subscriber units 260) and reverse links (i.e., transmissions on reverse logical channels from subscriber units 260 to communications networks 210). In one embodiment, base station 220 includes functionality, implemented in one or both of hardware and software, for digitally performing waveform processing to modulate and demodulate radio signals transmitted and received, respectively, by remote unit 240.

In the embodiment shown in FIG. 2, one or both of communications mediums 230 and 235 comprise one or more high speed digital data transport mediums. In one embodiment, communications medium 230 comprises one or more optical fibers utilizing wavelength division multiplexing to transmit forward logical channels from base station 220 to remote unit 240, and communications medium 235 comprises one or more optical fibers utilizing wavelength division multiplexing to transmit forward logical channels from remote unit 240 to base station 220. In another embodiment, one or both of communications mediums 230 and 235 comprise one or more optical fibers utilizing separate digital bit streams for forward logical channels and reverse logical channels. In another embodiment, one or both of communications mediums 230 and 235 comprises one optical fiber with forward logical channels and reverse logical channels utilizing different time slots of a single digital bit stream. These embodiments are presented as examples of possible high speed data transport mediums as it would be well understood by one in the art upon reading this specification that communications mediums 230 and 235 are not limited to optical fiber media but that other implementations of communications network 200 may also include other transport media such as copper wire, coaxial cable, twisted pair cable, or other electrical signal media, or a wireless communication link between base station 220 and remote unit 240.

FIG. 2 illustrates one embodiment of forward error correction for use in conjunction with communicating data in the downstream direction from upstream communications network 210 to subscriber unit 260, and in the upstream direction from subscriber unit 260 to communications network 210.

In the embodiment shown in FIG. 2, base station 220 comprises a call processing software module 221, a digital up converter 222, a forward error correction encoder 224 (FEC-EN), a wideband signal multiplexer 226 (MUX) and a signal transmitter 228. In one embodiment, digital up converter 222, and forward error correction encoder 224 (FEC-EN) process and transport data for one of a plurality of forward logical channels handled by base station 220. In one such embodiment, one or more additional digital up converters and forward error correction encoders process and transport data for each of the additional forward logical channels handled by base station 220.

In one embodiment, in the forward direction, base station 220 receives data in the form of representations of voice/data signals from upstream communications network 210. Call processing software module 221 generates digital representations of the voice/data signals from upstream communications network 210 into a stream of digital RF packets and provides the digital RF packets to digital up converter 222. In one embodiment, call processing software 221 modulates the representations of voice/data signals to a predetermined intermediate (i.e. baseband) frequency producing digital RF packets each comprising baseband modulated RF data samples representing the voice/data signals from upstream communications network 210.

Digital up converter 222 inputs the baseband RF data samples and remodulates the RF data samples to a frequency for one of a plurality of RF bands. Digital up converter 222 outputs the remodulated digital RF packets as a wideband digital signal representation of the voice/data signals. In one embodiment, digital up converter 222 converts a set of baseband RF data samples from the baseband frequency into a digital stream of complex digital RF data samples modulated at a center frequency designated for broadcasting with a particular RF channel assigned to the particular forward logical channel used to transport the digital RF packets. Increasing the center frequency of digital RF data samples results in remote unit 240 transmitting an RF signal at a higher radio frequency, while decreasing the center frequency of digital RF data samples results in remote unit 240 transmitting an RF signal at a lower radio frequency.

To provide forward error correction for the digital RF packets traveling towards subscriber unit 260, in one embodiment forward error correction encoder 224 (FEC-EN) inputs the wideband digital signal from digital up converter 222 and evaluates the contents of the digital RF packets traveling though each band of the wideband digital signal. Based on the contents of the digital RF packets, forward error correction encoder 224 incorporates forward error correction data into each of the digital RF packets. In one embodiment, multiplexer 226 inputs the digital RF packets received from forward error correction encoder 224 and multiplexes the digital RF packets into a serial stream of packets for serial transmission on communications medium 230.

In an alternate embodiment, the relative positions of multiplexer 226 and forward error correction encoder 224 within the signal path are reversed. In that case, multiplexer 226 inputs the digital RF packets from digital up converter 222 and multiplexes the digital RF packets into a serial stream of packets before forward error correction encoder 224 inputs the digital RF packets. In that case, forward error correction encoder 224 inputs the serial stream of packets from multiplexer 226, evaluates the contents of the digital RF packets, and incorporates forward error correction data into each of the digital RF packets before outputting the stream of digital RF packets to signal transmitter 228. Signal transmitter 228 transmits the stream of FEC modified digital RF packets to remote unit 240 via communications medium 230. In one embodiment, when communications medium 230 includes an optical fiber media, signal transmitter 228 is an optical transmitter such as, but not limited to a laser transmitter.

As shown in FIG. 2, remote unit 240 comprises a signal receiver 242, a wideband signal demultiplexer 244 (DE-MUX), a forward error correction decoder 246 (FEC-DC), a digital to analog converter 248, and a wireless RF transmitter 250.

Remote unit 240 receives the serialized stream of FEC modified digital RF packets from host unit 220 via signal receiver 242. In one embodiment, when signal receiver 242 is an optical receiver, signal receiver 242 includes one or more of a trans-impedance amplifier, a limiting amplifier and any clock and data recovery functionality necessary to convert an optical signal into an amplified electronic signal.

In one embodiment, a wideband signal demultiplexer 244 receives the amplified electronic signal from signal receiver 242 and de-multiplexes the serialized packets into a wideband signal. Forward error correction decoder 246 reads FEC modified digital RF packets from the wideband signal output of demultiplexer 244 and evaluates the forward error correction data from each FEC modified digital RF packet to determine whether the digital RF packet arrived error-free. When the packet is determined to be error-free, forward error correction decoder 246 strips the forward error correction data from the digital RF packet and forwards the digital RF packet to digital to analog converter 248. In one embodiment, when an error is detected within a FEC modified digital RF packet's RF data sample, forward error correction decoder 246 reconstructs a corrected RF data sample based on information contained within the forward error correction data as described above, and outputs a corrected digital RF packet to digital to analog converter 248. Digital to analog converter 248 converts digital RF packets received from forward error correction decoder 246 into an analog wideband RF signal which is wirelessly transmitted to one or more subscriber units 260 by wireless transmitter 250 via antenna 252.

In an alternate embodiment, forward error correction decoder 246 inputs the serialized stream of FEC modified digital RF packets received by signal receiver 242 and evaluates the forward error correction data from each digital RF packet to determine whether the digital RF packet arrived error-free, as described above. In that case, wideband signal demultiplexer 244 receives the digital RF packets from forward error correction decoder 246 and de-multiplexes the serialized packets into the wideband signal for processing by digital to analog converter 248 as described above.

In the embodiment shown in FIG. 2, to implement forward error correction in the upstream direction (i.e., from subscriber unit 260 to communications network 210) remote unit 240 further comprises a wireless RF receiver 270, an analog to digital converter 268, a forward error correction encoder 266 (FEC-EN), a wideband signal multiplexer 264 (MUX) and a signal transmitter 262.

In one embodiment, wireless receiver 270 receives RF signals via antenna 252 from one or more subscriber units 260. In one embodiment, wireless receiver 270 receives RF signals in multiple RF bands. Analog to digital converter 268 converts the analog RF signals into digital RF packets and outputs the digital RF packets as a wideband digital signal.

To provide forward error correction for the digital RF packets traveling towards upstream communications network 210, in one embodiment forward error correction encoder 266 (FEC-EN) inputs the wideband digital signal from analog to digital converter 268 and evaluates the contents of the digital RF packets traveling though each band of the wideband digital signal. Based on the contents of the digital RF packets, forward error correction encoder 266 incorporates forward error correction data into each of the digital RF packets.

In one embodiment, multiplexer 264 inputs the FEC modified digital RF packets received from forward error correction encoder 266 and multiplexes the digital RF packets into a serial stream of packets for serial transmission on communications medium 235.

In an alternate embodiment, multiplexer 264 inputs the digital RF packets directly from analog to digital converter 268 and multiplexes the digital RF packets into a serial stream of packets before forward error correction encoder 266 inputs the digital RF packets. In that case, forward error correction encoder 266 inputs the serial stream of packets from multiplexer 264, evaluates the contents of the digital RF packets, and incorporates forward error correction data into each of the digital RF packets before outputting the stream of FEC modified digital RF packets to signal transmitter 262. Signal transmitter 262 transmits the stream of FEC modified digital RF packets to base station 220 via communications medium 235. In one embodiment, when communications medium 235 includes an optical fiber media, signal transmitter 262 is an optical transmitter such as, but not limited to a laser transmitter.

As shown in FIG. 2, base station 220 comprises a signal receiver 288, a wideband signal demultiplexer 286 (DE-MUX), a forward error correction decoder 284 (FEC-DC), and a digital down converter 282. In one embodiment, digital down converter 282, and forward error correction decoder 284 (FEC-DC) process and transport data for one of a plurality of reverse logical channels handled by base station 220. In one such embodiment, one or more additional digital down converters and forward error correction encoders process and transport data for the each of the additional reverse logical channels handled by base station 220.

Signal receiver 288 receives the serialized stream of FEC modified digital RF packets from remote unit 240. In one embodiment, when signal receiver 288 is an optical receiver, signal receiver 288 includes one or more of a trans-impedance amplifier, a limiting amplifier and any clock and data recovery functionality necessary to convert an optical signal into an amplified electronic signal. In one embodiment, wideband signal demultiplexer 286 receives the amplified electronic signal from signal receiver 288 and de-multiplexes the serialized packets into a wideband signal. Forward error correction decoder 284 reads the FEC modified digital RF packets from the wideband signal output of demultiplexer 286 and evaluates the forward error correction data from each FEC modified digital RF packet to determine whether the digital RF packet arrived error-free. When the packet is determined to be error-free, forward error correction decoder 284 strips the forward error correction data from the digital RF packet and forwards the digital RF packet to digital down converter 282. In one embodiment, when an error is detected within a FEC modified digital RF packet's RF data sample, forward error correction decoder 284 reconstructs a corrected RF data sample based on information contained within the forward error correction data as described above, and outputs a corrected digital RF packet to digital down converter 282. Digital down converter 282 inputs the digital RF packets and remodulates RF data samples within the packets from an RF broadcast channel frequencies to a predetermined baseband frequency. Digital down converter 282 outputs the remodulated RF data samples to call processing software module 221. In one embodiment, call processing software module 221 generates voice/data signals from the RF data samples for transmission to upstream communications network 210.

In an alternate embodiment, forward error correction decoder 284 inputs the serialized stream of FEC modified digital RF packets received by signal receiver 288 and evaluates the forward error correction data from each FEC modified digital RF packet to determine whether the digital RF packet arrived error-free, as described above. In that case, wideband signal demultiplexer 286 receives the digital RF packets from forward error correction decoder 284 and de-multiplexes the serialized packets into the wideband signal for processing by digital down converter 282 as described above.

It would be appreciated by one skilled in the art that embodiments of the present invention, such as communications network 200, are not limited to communications networks based on any one RF modulation protocol. To the contrary, embodiments of the present invention handle multiple types of modulation protocols, and in different embodiments, one or more of the forward and reverse logical channels transmit data using a different modulation protocol than other forward and reverse logical channels. In one embodiment, base station 220 and remote unit 240 handle modulation protocols including one or more of, but not limited to, Advanced Mobile Phone System (AMPS), code division multiple access (CDMA), Wide-band CDMA (WCDMA), time division multiple access (TDMA), Global System for Mobile communications (GSM), Cellular Digital Packet Data (CDPD), Enhanced Data rates for GSM Evolution (EDGE), General Packet Radio Service (GPRS), Integrated Digital Enhanced Network (iDEN), Orthogonal Frequency Division Multiplexing (OFDM), High Speed Downstream Packet Access (HSDPA), or any other appropriate modulation protocol.

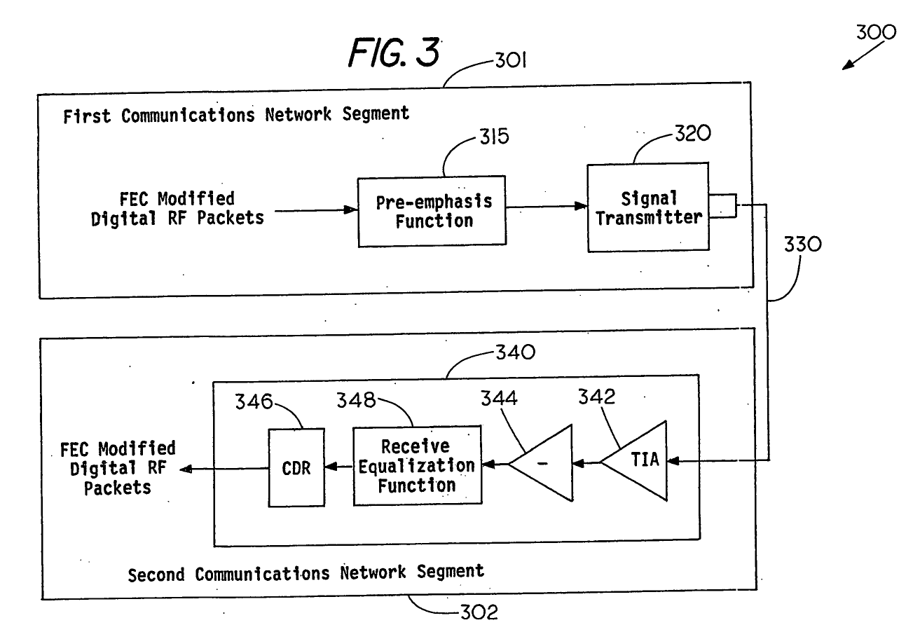

FIG. 3 is a block diagram illustrating the incorporation of one or both of pre-emphasis and receive equalization in a wideband digital RF transport system using forward error correction, such as those described above with respect to FIGS. 1 and 2, of one embodiment of the present invention. In one embodiment, a network 300 comprises a first communications network segment 301 coupled to communicated FEC modified packets to a second communications network segment 302 via a communications medium 330. In one embodiment, communications medium includes one or more high speed digital data transport mediums, such as but not limited to optical fiber, copper wire, coaxial cable, twisted pair cable, or other electrical signal media, or a wireless communication link.

In one embodiment, to reduce the potential for errors before the FEC modified packets are transmitted on the communications medium 330, first communications network segment 301 comprises a pre-emphasis function 315 that processes FEC modified packets prior to their transmission by signal transmitter 320. Pre-emphasis boosts high frequency components of the voice/data signals represented by digital data while leaving the lower frequency components at their original levels, thus effectively increase the signal to noise ratio of the digital data prior to transmitting the FEC modified packets via communication media 330.

In one embodiment, second communications network segment 302 comprises a signal receiver 340 for receiving the FEC modified packets via a communications medium 330. In one embodiment, when signal receiver 340 is an optical signal receiver, signal receiver 340 includes a trans-impedance amplifier 342, a limiting amplifier 344 and a clock and data recovery function 346 necessary for converting an optical signal into an amplified electronic signal. In one embodiment, signal receiver 340 further includes a receiver equalization function 348 which processes the digital data received via communication media 330 prior to clock and data recovery function 346 as illustrated in FIG. 3. Receiver equalization allows signal receiver 340 to overcome high frequency signal losses introduced by communication media 330. In one embodiment receiver equalization function 348 functions as a high pass filter and amplifier on the digital data received by signal receiver 340.

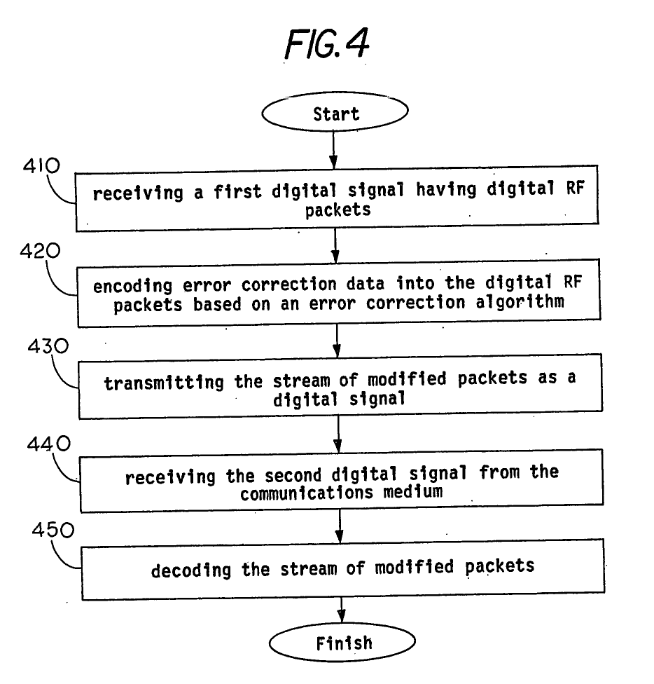

FIG. 4 is a flow chart illustrating a method for transmitting digital data in a wideband digital RF transport system of one embodiment of the present invention. The method starts at 410 with receiving a first digital signal having digital RF packets comprising data samples of a digitized wideband RF spectrum. In one embodiment, the data samples represent modulated voice and data signals. In one embodiment, the data samples are up-converted from a baseband modulation frequency to a broadcast channel frequency, as described with respect to FIG. 2 above. The method proceeds to 420 with encoding error correction data into the digital RF packets based on an error correction algorithm. The result is a stream of digital RF packets which are modified based on the error correction data. In one embodiment, encoding error correction data comprises applying an error correction algorithm based on one or both of block coding and convolutional coding. Examples of block coding include, but are not limited to Reed-Solomon coding, Golay coding, BCH coding and Hamming coding. Examples of convolutional coding include, but are not limited to the Viterbi algorithm. In one embodiment, a forward error correction encoder applies an encoding algorithm based on turbo coding, a scheme that combines two or more relatively simple convolutional codes and an interleaver to produce a block code. Examples of turbo coding include, but are not limited to 1xEV-DO (TIA IS-856). Other forms of forward error correction algorithms which may be utilized by embodiments of the present invention include, but are not limited to check bits, digital fountain code, differential space-time code, erasure codes, binary Golay codes, ternary Golay codes, Hagelbarger code, Hamming code, a low-density parity-check (LDPC) code, Reed-Muller code, and space-time trellis codes (STTCs). As would be appreciated by one skilled in the art upon reading this specification, the choice of which forward error correction algorithm to use can be readily determined based on network specifics. The method then proceeds to 430 with transmitting the stream of modified packets as a digital signal via a communications medium, such as but not limited to, a fiber optic cable.

In one embodiment, the method continues at 440 with receiving the digital signal from the communications medium, and proceeds to 450 with decoding the stream of modified packets. Decoding the modified packets determines whether the stream of modified packets arrived error-free based on the error correction data encoded into the packets. In one embodiment, when a modified packet is determined to have been received error-free, the method removes the error correction data from the modified packet and outputs the original digital RF packet. When a modified packet is determined to have arrived with one or more errors, the method reconstructs a digital RF packet based on the error correction data encoded in the modified packet, and outputs a corrected digital RF packet. In one embodiment, the method continues with generating an analog wideband RF spectrum signal based on the decoded digital RF packets received from the communications medium. In another embodiment, data samples within the decoded digital RF packets are down-converted from a broadcast channel frequency to a baseband modulation frequency, as described with respect to FIG. 2 above.

Several means are available to implement the forward error correction encoders and decoders, pre-emphasis functions and receiver equalization functions discussed above. These means include, but are not limited to, digital computer systems, programmable controllers, or field programmable gate arrays. Therefore other embodiments of the present invention are program instructions resident on computer readable media which when implemented by such processors, enable the processors to implement embodiments of the present invention. Computer readable media include any form of computer memory, including but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method for transmitting digital data in a wideband digital RF transport system, the method comprising:
receiving a first digital signal, wherein the digital signal includes a stream of digital RF packets, each digital RF packet comprising one or more data samples representing a digitized wideband RF spectrum;
encoding error correction data into the stream of digital RF packets based on an error correction algorithm to produce a stream of modified packets; and
transmitting a second digital signal comprised of the stream of modified packets via a communications medium.

2. The method of claim 1, wherein receiving a first digital signal comprises receiving a signal modulated based on one or more of an Advanced Mobile Phone System (AMPS) modulation protocol, a code division multiple access (CDMA) modulation protocol, a Wide-band CDMA (WCDMA) modulation protocol, a time division multiple access (TDMA) modulation protocol, a Global System for Mobile communications (GSM) modulation protocol, a Cellular Digital Packet Data (CDPD) modulation protocol, an Enhanced Data rates for GSM Evolution (EDGE) modulation protocol, a General Packet Radio Service (GPRS) modulation protocol, an Integrated Digital Enhanced Network (iDEN) modulation protocol, and an Orthogonal Frequency Division Multiplexing (OFDM) modulation protocol.

3. The method of claim. 1, wherein transmitting a second digital signal further comprises transmitting the second digital signal via one or more of fiber optic cable, wire cable, coaxial cable, twisted pair cable, and a wireless communication link.

4. The method of claim 1, wherein encoding error correction data into the stream of digital RF packets further comprises executing a error correction algorithm based on one or more of block coding, convolutional coding, turbo coding, Reed-Solomon coding, BCH coding, Hamming coding, a Viterbi algorithm, 1xEV-DO coding, check bits, digital fountain code, differential space-time code, erasure codes, binary Golay codes, ternary Golay codes, Hagelbarger code, a low-density parity-check (LDPC) code, Reed-Muller code, and space-time trellis codes (STTCs).

5. The method of claim 1, further comprising one or both of:
multiplexing the stream of digital RF packets into a serialized stream of digital RF packets; and
multiplexing the stream of modified packets into a serialized stream of modified packets.

6. The method of claim 1, further comprising:
digitally up-converting the stream of digital RF packets from a baseband modulation frequency to a broadcast channel frequency.

7. The method of claim 1, further comprising:
receiving the second digital signal from the communications medium; and
decoding the stream of modified packets to determine whether the stream of modified packets arrived error-free.

8. The method of claim 7, wherein, when a modified packet of the stream of modified packets is determined to have arrived error-free, the method further comprises:
stripping error correction data from the modified packet; and
outputting a restored digital RF packet.

9. The method of claim 7, wherein, when a modified packet of the stream of modified packets is determined to have arrived with one or more errors, the method further comprises:
reconstructing a digital RF packet based on the error correction data encoded in the modified packet; and
outputting a corrected digital RF packet.

10. The method of claim 7, further comprising:
generating an analog wideband RF spectrum signal based on decoded digital RF packet from the second digital signal.

11. The method of claim 7, further comprising one or both of:
de-multiplexing the decoded stream of modified packets into a digital wideband signal; and
de-multiplexing the stream of modified packets into a digital wideband signal.

12. The method of claim 7, further comprising one or both of:
digitally down-converting decoded digital RF packets to a baseband modulation frequency.

13. A computer-readable medium having computer-executable program instructions for a method for communicating digital RF data in a communications network, the method comprising:
inputting a stream of digital RF packets, wherein each digital RF packet comprises one or more data samples representing a digitized wideband RF spectrum;
encoding each digital RF packet of the stream of digital RF packets with error correction data; and
outputting a stream of error correction encoded data packets based on the digital RF packets.

14. The computer-readable medium of claim 13, wherein encoding each digital RF packet of the stream of digital RF packets further comprises executing a error correction algorithm based on one or more of block coding, convolutional coding, turbo coding, Reed-Solomon coding, BCH coding, Hamming coding, a Viterbi algorithm, 1xEV-DO coding, check bits, digital fountain code, differential space-time code, erasure codes, binary Golay codes, ternary Golay codes, Hagelbarger code, a low-density parity-check (LDPC) code, Reed-Muller code, and space-time trellis codes (STTCs).

15. The computer-readable medium of claim 13 further comprising applying a pre-emphasis function to the stream of error correction encoded data packets.

16. A computer-readable medium having computer-executable program instructions for a method for communicating digital RF data in a communications network, the method comprising:
inputting a stream of data packets, wherein each packet comprises one or more data samples representing a digitized wideband RF spectrum encoded with error correction data;
decoding each data packet to determine whether the one or more data samples were received without errors; and
outputting a stream digital RF packets, wherein each digital RF packet comprises one or more data samples representing the digitized wideband RF spectrum.

17. The computer-readable medium of claim 16, wherein decoding each data packet to determine whether the one or more data samples were received without errors further comprises executing a error correction algorithm based on one or more of block coding, convolutional coding, turbo coding, Reed-Solomon coding, BCH coding, Hamming coding, a Viterbi algorithm, 1xEV-DO coding, check bits, digital fountain code, differential space-time code, erasure codes, binary Golay codes, ternary Golay codes, Hagelbarger code, a low-density parity-check (LDPC) code, Reed-Muller code, and space-time trellis codes (STTCs).

18. The computer-readable medium of claim 16 further comprising applying a receive equalization function to the stream of data packets.

19. A communication network, the network comprising:
means for encoding a stream of digital RF packets with error correction data based on a forward error correction algorithm, wherein each digital RF packet of the stream of digital RF packets comprises one or more data samples representing a digitized wideband RF spectrum, the means for encoding further adapted to output a stream of error correction encoded digital RF packets; and
means for communicating a digital signal to a communication medium, the means for communicating responsive to the means for encoding, wherein the means for communication a digital signal is adapted to communicate the stream of error correction encoded packets to the communication medium.

20. A communications network comprising, the network comprising:
means for receiving a digital signal, wherein the digital signal comprises a stream of error correction encoded digital RF packets; and
means for decoding the stream of error correction encoded digital RF packets based on a forward error correction algorithm, the means for decoding further adapted to extract from each digital RF packet of the stream of error correction encoded digital RF packets one or more data samples representing a digitized wideband RF spectrum.

21. The network of claim 20, wherein the means for decoding is further adapted to determine whether each digital RF packet of the stream of error correction encoded digital RF packets was received error-free by the means for receiving a digital signal.

22. The network of claim 21 wherein, when the means for decoding determines a digital RF packet of the stream of error correction encoded digital RF packets was received error-free, the means for decoding is further adapted to:
remove error correction data from the digital RF packet; and
output a restored digital RF packet.

23. The network of claim 21 wherein when the means for decoding determines a digital RF packet of the stream of error correction encoded digital RF packets includes one or more error, the means for decoding is further adapted to:
reconstruct one or more data samples representing a digitized wideband RF spectrum based on the error correction data encoded in the error correction encoded digital RF packets; and
outputting a corrected digital RF packet.

24. A wideband digital RF transport system, the system comprising:
a first communications network segment adapted to incorporate forward error correction data into one or more digitized data samples based on an error correction encoding algorithm, wherein the one or more digitized data samples represent a wideband RF spectrum signal, the first communications network segment further adapted to output a digital signal representing the forward error correction encoded data samples;
a second communications network segment adapted to receive the digital signal and apply an error correction decoding algorithm to the error correction encoded data samples; and
a communications medium coupled to the first communications network segment and the second communications network segment, the communications medium adapted to communicate the digital signal from the first communications network segment to the second communications network segment.

25. The system of claim 24, wherein the first communications network segment includes a base station comprising:
a call processing software module adapted to receive signals from an upstream communications network and generate digital RF packets based on the signals, the digital RF packets including one or more data samples representing a digitized wideband RF spectrum; and
a forward error correction encoder adapted to receive the digital RF packets and incorporate forward error correction data into the digital RF packets.

26. The system of claim 25, the base station further comprising:
at least one digital up converter adapted to receive the digital RF packets generated by the call processing software, the digital up converter further adapted to remodulate the digital RF packets from a baseband frequency to a broadcast channel frequency

27. The system of claim 25, the base station further comprising:
a wideband signal multiplexer adapted to convert a wideband digital RF signal into a serialized stream of digital RF packets; and
a signal transmitter coupled to the wideband signal multiplexer and adapted to transmit the serialized stream of digital RF packets via a communications medium.

28. The system of claim 25, wherein the forward error correction encoder is adapted to implement an error correction algorithm based on one or more of block coding, convolutional coding, turbo coding, Reed-Solomon coding, BCH coding, Hamming coding, a Viterbi algorithm, 1xEV-DO coding, check bits, digital fountain code, differential space-time code, erasure codes, binary Golay codes, ternary Golay codes, Hagelbarger code, a low-density parity-check (LDPC) code, Reed-Muller code, and space-time trellis codes (STTCs).

29. The system of claim 25, the base station further comprising:
a signal receiver adapted to receive a second digital signal from the communications medium, the second digital signal including a stream of error correction encoded digital RF packets having one or more data samples representing a digitized wideband RF spectrum; and
a forward error correction decoder coupled to the signal receiver and adapted to determine whether the error correction encoded data samples were received error free.

30. The system of claim 25, the base station further comprising:
at least one digital down converter adapted to receive decoded digital RF packets from the a forward error correction decoder and remodulate the digital RF packets to a baseband frequency.

31. The system of claim 24, wherein the second communications network segment includes a remote unit comprising:
a signal receiver adapted to receive the digital signal from the communications medium; and
a forward error correction decoder coupled to the signal receiver and adapted to decode the error correction encoded data samples, wherein the forward error correction decoder is further adapted to determine whether the error correction encoded data samples were received error free based on an error correction algorithm.

32. The system of claim 31, the remote unit further comrprises:
a digital to analog converter adapted to convert decoded data samples into a wideband RF spectrum signal; and
a wireless RF transmitter adapted to wirelessly broadcast the wideband RF spectrum signal.

33. The system of claim 31, the remote unit further comrprises:
a forward error correction encoder adapted to receive digital RF packets and incorporate forward error correction data into the digital RF packets; and
a signal transmitter coupled to communicate with the forward error correction encoder and adapted to transmit forward error correction encoded digital RF packets via the communications medium.

34. The system of claim 24, the first communications network segment further comprising a pre-emphasis function, the pre-emphasis network adapted to boosts high frequency components of the one or more digitized data samples.

35. The system of claim 24, the second communications network segment further comprising a receive equalization function, the receive equalization function adapted to implement a high pass filter on the digital signal and amplify the digital signal.
